(19) United States
(12) Patent Application Publication
(10) Pub. No.: US 2008/0010642 A1
(43) Pub. Date: Jan. 10, 2008

(54) METHOD, SYSTEM AND COMPUTER PROGRAM FOR SCHEDULING EXECUTION OF WORK UNITS WITH MONITORING OF PROGRESS THEREOF

(76) Inventors: Scot MacLellan, Roma (IT); Ivan Orlandi, Rome (IT)

Correspondence Address: IBM CORPORATION;INTELLECTUAL PROPERTY LAW, 11400 BURNET ROAD, AUSTIN, TX, 78758, US

(21) Appl. No.: 11/768,302

(22) Filed: Jun. 26, 2007

(30) Foreign Application Priority Data
Jun. 30, 2006 (EP) 06116485.1

(51) Int. Cl. G06F 9/46

(52) U.S. Cl. 718/102

(57) ABSTRACT

A solution (400) for scheduling execution of jobs is proposed. The submission of the jobs is generally controlled according to a production plan (406), which specifies a required finish time of critical jobs. In the proposed solution, a current progress of each critical job is monitored (427-430)—such as comparing a (measured) number of processor cycles dedicated to the critical job with an estimated total number thereof (required to complete the critical job, as inferred from previous executions thereof). At the same time, an expected progress of each critical job is estimated (433)—such as by the ratio between a time elapsed from an actual start time of the critical job and an allowable duration thereof (from the actual start time to the required finish time). The current progress of each critical job is then compared with its expected progress, so as to identify (436) the critical jobs that are late in their execution. Additional execution resources can then be assigned to each late critical job only when it is necessary to bring back the critical job on schedule.

### FIELD OF THE INVENTION

The present invention relates to the information technology field. More specifically, the invention relates to the scheduling of work units in a data processing system.

### BACKGROUND ART

Scheduling of different work units (for example, batch jobs) is a commonplace activity in data processing systems. For this purpose, workload schedulers have been proposed in the last years to automate the submission of large quantities of jobs from a central point of control; an example of commercial scheduler is the “IBM Tivoli Workload Scheduler (TWS)” by IBM Corporation.

A typical problem of the schedulers is that of ensuring that the jobs are executed when it is required. For this purpose, any scheduler controls the submission of the jobs for their execution according to a specific plan. The plan defines the flow of execution of the jobs in a specific production period (such as one day). The plan is created according to the dependencies of the jobs on the completion of other jobs. Starting from the end of each dependency path and proceeding backwards, the scheduler assigns a required start time to a last job, so as to ensure that it completes (according to an estimated duration thereof) before a required finish time; the scheduler likewise plans the execution of each preceding job to ensure that it completes in time to allow the correct execution of any next job depending thereon.

This is particularly critical for jobs that must be executed in a very strict timeframe; examples of these critical jobs are the ones to be completed by a certain deadline, or the ones conditioning the execution of dependent jobs having similar time constraints.

The schedulers known in the art are generally capable of detecting delays in the execution of the jobs; for example, the jobs are considered late when they are submitted for execution after the corresponding required start times, or when they complete after their required finish times.

Typically, the schedulers warn an operator for any late jobs (such as by means of system alerts or e-mail notifications); in this way, the operator may intervene to try solving the problem (for example, by cancelling non-critical jobs to dedicate more resources to important jobs or by starting execution of the late jobs manually).

Some schedulers also support a facility to automatically mitigate the impact of late starting jobs. In this case, the scheduler interacts with a workload manager to assign additional execution resources of the system to the late jobs (in an attempt to speedup their execution).

Although quite useful, the above-described solution is not completely satisfactory. Indeed, it is very difficult (if not impossible) to distribute the available resources correctly to the different jobs. Indeed, in many cases additional resources are assigned to the jobs even when it is not strictly necessary. Therefore, it is possible to overcompensate the execution of some jobs so as to complete them even before the corresponding required finish times; moreover, this result might be achieved by withdrawing resources to other jobs, which are then starved with the risk of impairing their correct execution.

All of the above does not allow optimizing the flow of execution of the plan as a whole. Particularly, the above-mentioned side effects may defeat the advantages provided by the allocation of the additional resources to the late jobs.

This problem is particularly acute for critical jobs, wherein it is of the utmost importance to complete them within the required timeframes.

### SUMMARY OF THE INVENTION

In its general form, the present invention is based on the idea of monitoring the actual progress of the jobs.

Particularly, the present invention provides a solution as set out in the independent claims. Advantageous embodiments of the invention are described in the dependent claims.

More in detail, an aspect of the invention proposes a method for scheduling execution of work units (such as jobs) in a data processing system. The method starts with the step of providing a plan of execution of the work units; the plan specifies a required finish time of one or more critical work units. Each work unit is submitted for execution at a corresponding start time. The method continues by monitoring a current progress of the execution of each critical work unit at a current time. An expected progress of the execution of each critical work unit is then estimated at the same current time; the expected progress is estimated according to a time elapsed from the start time to the current time, with respect to an allowable duration from the start time to the finish time. An indication of lateness of each critical work unit is then determined according to a comparison between the current progress and the expected progress.

In an embodiment of the invention, execution resources of the system (assigned to each critical job) are updated according to the corresponding lateness.

Typically, additional resources are assigned to each critical job when it is late, whereas the same additional resources are withdrawn as soon as the critical job returns on schedule.

Preferably, the current progress of each critical job is based on the ratio between a measured number of predetermined operations (such as processor cycles) performed by the critical job and a total number of the same operations (required to complete the critical job).

A suggested way for predicting the total number of operations is that of estimating it according to measured values of previous executions of the critical job.

As a further improvement, the estimated total number of operations is adjusted according to a classification of the critical job (based on one or more attributes thereof—such as its planned time of execution).

In a preferred embodiment of the invention, the expected progress is calculated as the ratio between the time elapsed and the available duration.

As a further improvement, the monitoring of each critical job is disabled when the difference between the required finish time and the current time is lower that a threshold value.

Another aspect of the invention proposes a computer program for performing the method.

A further aspect of the invention proposes a corresponding system.

### REFERENCE TO THE DRAWINGS

The invention itself, as well as further features and the advantages thereof, will be best understood with reference to the following detailed description, given purely by way of a nonrestrictive indication, to be read in conjunction with the accompanying drawings, in which:

FIG. 1 is a schematic block diagram of a data processing system in which the solution according to an embodiment of the invention is applicable;

FIG. 2 illustrates an exemplary application of the solution according to an embodiment of the invention;

FIG. 3 is a collaboration diagram representing the roles of different software modules implementing the solution according to an embodiment of the invention; and

FIGS. 4a-4b show a diagram describing the flow of activities relating to the implementation of the solution according to an embodiment of the invention.

### DETAILED DESCRIPTION

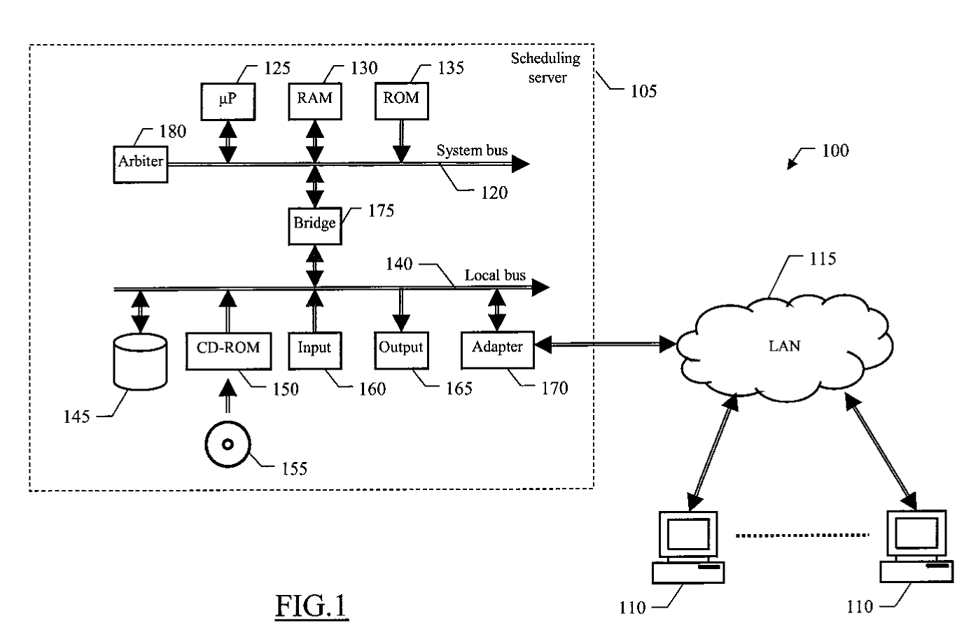

With reference in particular to FIG. 1, a data processing system 100 with distributed architecture is illustrated. The system 100 includes a central scheduling server 105, which is used to automate, monitor and control the execution of jobs in the system 100. Typically, the jobs consist of non-interactive tasks (for example, relating to accounting applications), which are to be executed on a set of workstations 110. For this purpose, the scheduling server 105 and the workstations 110 communicate through a network 115—such as a Local Area Network (LAN).

More specifically, the scheduling server 105 is formed by several units that are connected in parallel to a system bus 120. In detail, multiple microprocessors (μP) 125 control operation of the scheduling server 105; a REM 130 is directly used as a working memory by the microprocessors 125, and a ROM 135 stores basic code for a bootstrap of the scheduling server 105. Several peripheral units are clustered around a local bus 140 (by means of respective interfaces). Particularly, a mass storage consists of one or more hard-disks 145 and drives 150 for reading CD-ROMs 155. Moreover, the scheduling server 105 includes input units 160 (for example, a keyboard and a mouse), and output units 165 (for example, a monitor and a printer). An adapter 170 is used to connect the scheduling server 105 to the network 115. A bridge unit 175 interfaces the system bus 120 with the local bus 140. Each microprocessor 125 and the bridge unit 175 can operate as master agents requesting an access to the system bus 120 for transmitting information. An arbiter 180 manages the granting of the access with mutual exclusion to the system bus 120.

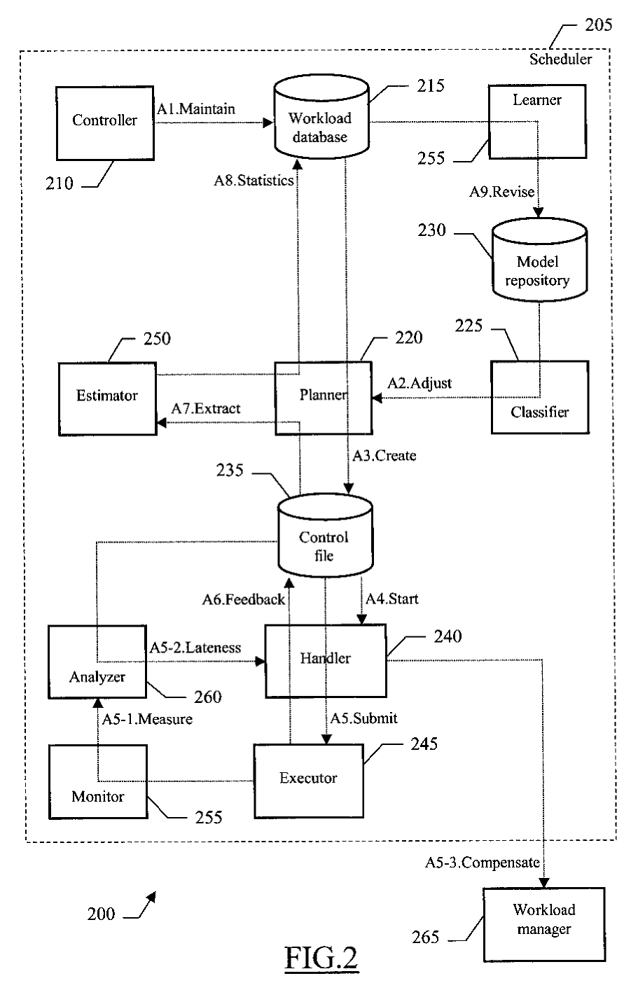

Moving to FIG. 2, the main software modules that run on the scheduling server are denoted as a whole with the reference 200. The information (programs and data) is typically stored on the hard-disk and loaded (at least partially) into the working memory of the scheduling server when the programs are running. The programs are initially installed onto the hard disk, for example, from CD-ROM. Particularly, the figure describes the static structure of the system (by means of the corresponding modules) and its dynamic behavior (by means of a series of exchanged messages, which are denoted with progressive sequence numbers preceded by the symbol “A”).

More in detail, the scheduling server runs a corresponding application 205 (for example, the above-mentioned “TWS”). The scheduler 205 includes a controller 210 (such as the “Composer” program in the case of the “TWS”), which is used to maintain a workload database 215 (action “A1.Maintain”).

The workload database 215 contains the definition of the whole scheduling environment. Particularly, the workload database 215 stores a representation of the topology of the system (i.e., the workstations with their connections) and of the hardware/software resources that are available for the execution of the jobs. The workload database 215 also includes a descriptor of each job, which defines rules controlling its execution (written in a suitable control language, for example, XML-based). More specifically, the job descriptor specifies the programs to be invoked, their arguments and environmental variables. The execution of the job is typically conditioned by a set of dependencies (which must be met before the job can start); exemplary dependencies are time constraints (such as its run-cycle, like every day, week or month), sequence constraints (such as the successful completion of other jobs), or enabling constraints (such as the entering of a response to a prompt by an operator). The job descriptor also specifies the (physical or logical) resources that are required by the job; those resources can be seen as further dependencies, which condition the execution of the job to their availability. At the end, the job descriptor includes statistics information of the job; for example, the statistics information provides a log of an actual duration of previous executions of the job, from which an estimated duration for its next executions may be inferred.

The execution of some specific jobs may be particular critical (such as for jobs relating to vital business activities); typically, each critical job must be executed in a very strict timeframe. For example, this is the case when a result of the critical job is required by a certain deadline (such as a job providing payrolls for the pay-day). Another example is a job inserted in a dependency path, wherein the execution of one or more critical jobs is conditioned on its completion (such as a job processing timecards for the above-mentioned job processing the payrolls); in this case, the timely completion of the job is necessary to ensure the correct execution flow of the (critical) path. In any case, the corresponding job descriptor specifies a further time constraint consisting of a required finish time of the critical job—from which a required start time may be determined according to the estimated duration of the critical job.

A planner 220 (such as the “Master Domain Manager” of the “TWS”) creates a workload plan; the plan consists of a batch of jobs—together with their dependencies—scheduled for execution on a specific production period (typically, one day). A new plan is generally created automatically before every production period. For this purpose, the planner 220 processes the information available in the workload database 215 so as to select the jobs to be run and to arrange them in the desired sequence (according to their dependencies and expected duration).

Preferably, the planner 220 also interfaces with a classifier 225, which accesses a model repository 230. For each job, the model repository 230 stores a decision tree, which classifies different executions of the job according to corresponding attributes; a typical example of these attributes is a planned time of execution of the job (such as a day of the week, a day of the month, and a month of the year). Each class of executions of the job is associated with a corresponding correction factor for its estimated duration. The classifier 225 assigns each job to be planned to the corresponding class by sorting down its decision tree in the model repository 230 (according to the relevant attributes of the job received from the planner 220); the adjustment factor associated with the class of the job is then used to adjust its estimated duration (action “A2.Adjust”). A more detail description of this technique is provided in US-A-2002-0194247 (the entire disclosure of which is herein incorporated by reference).

The planner 220 creates the plan by adding the jobs to be executed (for the next production period) and by removing the preexisting jobs (of the previous production period) that have been completed; in addition, the jobs of the previous production period that did not complete successfully or that are still running or waiting to be run can be maintained in the plan (for their execution during the next production period). The plan so obtained is then stored into a corresponding control file 235—such as the “Symphony” of the “TWS” (action “A3.Create”).

A handler 240 (such as the “Batchman” process of the “TWS”) starts the plan at the beginning of every production period (action “A4.Start”). The handler 240 submits each job of the plan for execution as soon as possible—according to its dependencies (Action “A5.Submit”). The actual execution of the job is managed by a corresponding module 245 (such as the “Jobman” process of the “TWS”). The executor 245 directly launches and tracks the job, by interfacing with an agent (not shown in the Figure) running on the workstation assigned thereto. The executor 245 returns feedback information about the execution of the job to the handler 240 (for example, whether the job has been completed successfully, its actual duration, and the like); the handler 240 enters this feedback information into the control file 235, so as to have a real-time picture of the current state of all the jobs of the plan (action “A6.Feedback”).

At the end of the production period, the planner 220 extracts the feedback information of the completed jobs from the control file 235 and passes it to an estimator 250 (action “A7.Extract”). The estimator 250 revises the statistics information relating to the completed jobs accordingly, and updates it in the workload database 215 through the planner 220 (action “A8.Statistics”). Particularly, the estimator 250 calculates the estimated duration of each job as a running average of the actual duration of its previous executions; for example, the actual duration of the job just executed (when completed successfully) is multiplied by a factor with a value decreasing according to the number of previous executions of the job, and the result is used for updating its estimated duration. At the same time, a learner 255 revises the decision trees of the completed jobs in the model repository 230 according to their up-to-date statistics information available in the workload database 215 (action “A9.Revise”); particularly, the learner 255 builds the decision trees (either in an incremental mode or in a non-incremental mode) by using the feedback information of the previous executions of the completed jobs as training examples.

As described in detail in the following, in the solution according to an embodiment of the present invention the scheduler 205 also monitors a current progress of the execution of each critical job; for example, the current progress is defined by the number of processor cycles of the corresponding workstation dedicated to the critical job at a current time, with respect to an estimated total number of processor cycles required to complete the critical job (typically inferred from an actual total number of the processor cycles that were dedicated to its previous executions). The current progress of the critical job is compared with an expected progress thereof at the same current time; the expected progress is estimated according to the time elapsed from its actual start time with respect to an allowable duration (from the actual start time of the critical job to its required finish time). In this way, the scheduler 205 can determine when each critical job is late in its execution (and then it is likely not to complete before the required finish time). Additional resources can then be assigned to any late critical jobs for speeding-up their execution.

The proposed solution facilitates the correct distribution of the available resources to the different critical jobs. Particularly, this allows gauging the degree of assistance that is provided to each critical job being late.

For example, it is possible to assign the additional resources to the critical jobs only when it is really necessary (according to their actual progress). Moreover, it is also possible to avoid overcompensating the execution of some late critical jobs—by withdrawing the additional resources as soon as the critical jobs return on schedule.

The proposed technique prevents starving other critical jobs, so as to avoid the risk of impairing their correct execution.

All of the above allows optimizing the flow of execution of the whole plan, with a beneficial impact on the plan as a whole.

These advantages are clearly perceived for critical jobs relating to vital business applications, since they facilitate the completion of these critical jobs within the required timeframes.

More specifically, the statistics information in the job descriptor of each critical job (stored in the workload database 215) now also includes a log of the actual total processor cycles of the previous executions of the critical job (from which the corresponding estimated total processor cycles of its next executions may be inferred). For this purpose, the feedback information that is returned by the executor 245 to the handler 240 after the completion of each critical job (see action “A6.Feedback”) further includes its actual total processor cycles (that were dedicated to the critical job by the corresponding workstation where it was executed); for example, this information can be retrieved through a specific Application Program Interface (API) of an operating system of the workstation, or from its system log. The proposed metric for defining the progress of the critical jobs is easy to measure and at the same time very accurate; moreover, this solution is of general applicability (since the number of processor cycles signify the real progress of most types of jobs). At the end of the production period, the estimator 250 also revises the estimated total processor cycles of each completed critical job (see action “A8.Statistics”); for example, the estimated total processor cycles are calculated as above as the running average of the actual total processor cycles of its previous executions. Preferably, the estimated total processor cycles of each critical job to be planned are adjusted as above according to the same adjustment factor that is used by the classifier 225 to adjust is estimated duration (see action “A2.Adjust”).

The above-described technique allows predicting the estimating total processor cycles of the critical jobs in a very accurate way. Particularly, the additional feature of revising the estimated total processor cycles of each critical job according to its classification accounts for the differences among the executions of the same critical job. In this way, it is now possible to discriminate the circumstances that alter the executions of the critical job; for example, a critical job processing payment orders will generally require more processor cycles at the end of every month (when several payment deadlines expire), since more data must be processed.

Periodically (for example, every 1-5 minutes), a monitor 255 measures the current processor cycles of each critical job that is running at the moment, as indicated by the executor 245 (action “A5-1.Measure”). The information is supplied to an analyzer 260; as described in detail in the following, for each (running) critical job the analyzer 260 calculates its current progress from the actual processor cycles (received from the monitor 255) and the estimated total processor cycles (extracted from the control file 235 after their adjustment by the classifier 225). The current progress of the critical job is then compared with its expected progress (estimated according to the time elapsed from the actual start time of the critical job with respect to its allowable duration, extracted from the control file 235 as well). This operation generates a safety index indicative of the lateness of the critical job, which safety index is then returned to the handler 240 (action “A5-2.Lateness”).

The handler 240 controls the execution of the critical jobs according to their safety indexes (action “A5-3.Compensate”). Particularly, whenever a critical job is late (i.e., its safety index falls below a predefined threshold) the handler 240 instructs a workload manager 265 to assign additional resources to the critical job (such as more processor time, working memory, and the like). Conversely, when a critical job that was previously late returns on schedule (i.e., its safety index reaches again the desired threshold) the same additional resources are withdrawn from the critical job.

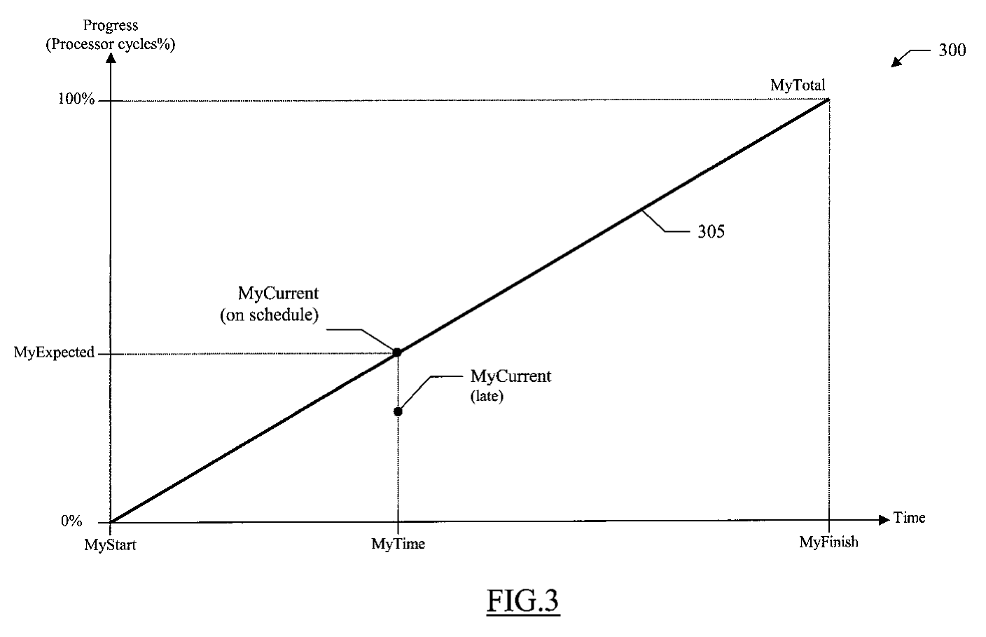

An exemplary application of the above-described technique is illustrated in FIG. 3. The figure provides a graph 300 for a generic critical job, having the time on the axis of the abscissas and the progress (as a percentage of its processor cycles) on the axis of the ordinates. The critical job was submitted for execution at the actual start time MyStart (taken as the origin of the axis of the abscissas for the sake of simplicity). The critical job must complete before the required finish time MyFinish, so that its allowable duration MyDuration will be:

MyDuration=MyFinish−MyStart.

The completion of the critical job requires the estimated total processor cycles MyTotal. Therefore, assuming that the progress of the critical job is linear—i.e., the current processor cycles are proportional to the elapsed time from the actual start time MyStart—the expected progress MyExpected at any current time MyTime is defined by a line 305 extending from 0% at the actual start time MyStart to 100% at the required finish time MyFinish:

$$MyExpected = \frac{My Time}{MyDuration} .$$

The current progress MyCurrent of the critical job at the same current time MyTime is instead given by the ratio between the current processor cycles MyCycles and the estimated total processor cycles MyTotal:

$$MyCurrent = \frac{MyCycles}{MyTotal} .$$

The safety index MySafety at the current time MyTime is simply given by the ratio between the current progress MyCurrent and the expected progress MyExpected (at the current time MyTime):

$$\begin{matrix}MySafety = MyCurrent / MyExpected \\ = ( \frac{MyCycles}{MyTotal} ) / ( \frac{MyTime}{MyDuration} )\end{matrix}$$

When the critical job is perfectly on schedule, the current progress MyCurrent is equal to the expected progress MyExpected (so that the current progress MyCurrent is on the line 305); in this case, the safety index MySafety will be:

MySafetety=MyCurrent/MyExpected=1/1=1.

Conversely, when the critical job is late the current progress MyCurrent is lower than the expected progress MyExpected (so that the current progress MyCurrent is below the line 305); in this case, the safety index MySafety will be:

MySafety=MyCurrent:MyExpected<1

(of course, when the critical job is early the current progress MyCurrent is higher than the expected progress MyExpected, and the safety index MySafety>1).

Preferably, the critical job is deemed really late when its safety index MySafety is lower than a predefined tolerance value TV—such as TV=0.9-0.95 (i.e., MySafety<TF). The tolerance value TV accounts for slight deviations of the progress of the critical job from the assumed (ideal) linear law; moreover, it avoids compensating minor drifting of the execution of the critical job from its expected progress.

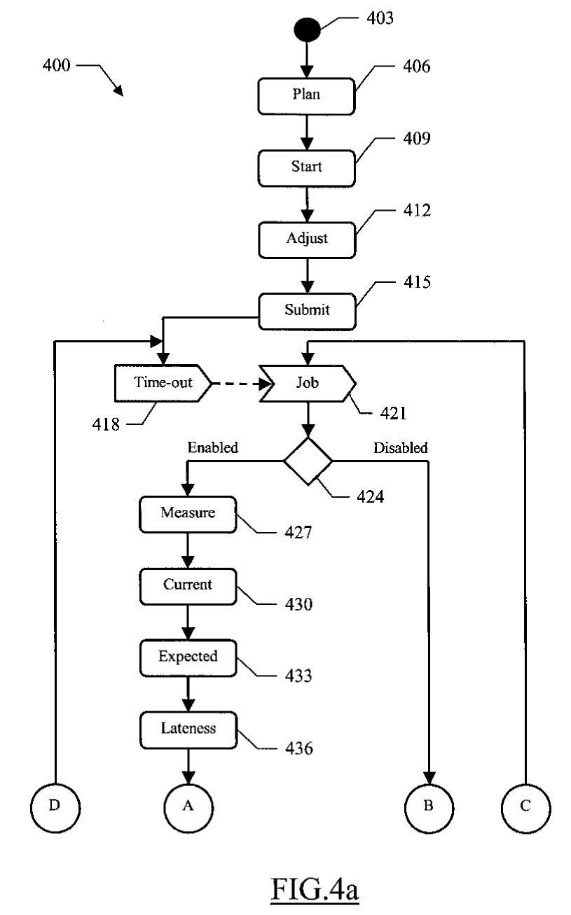

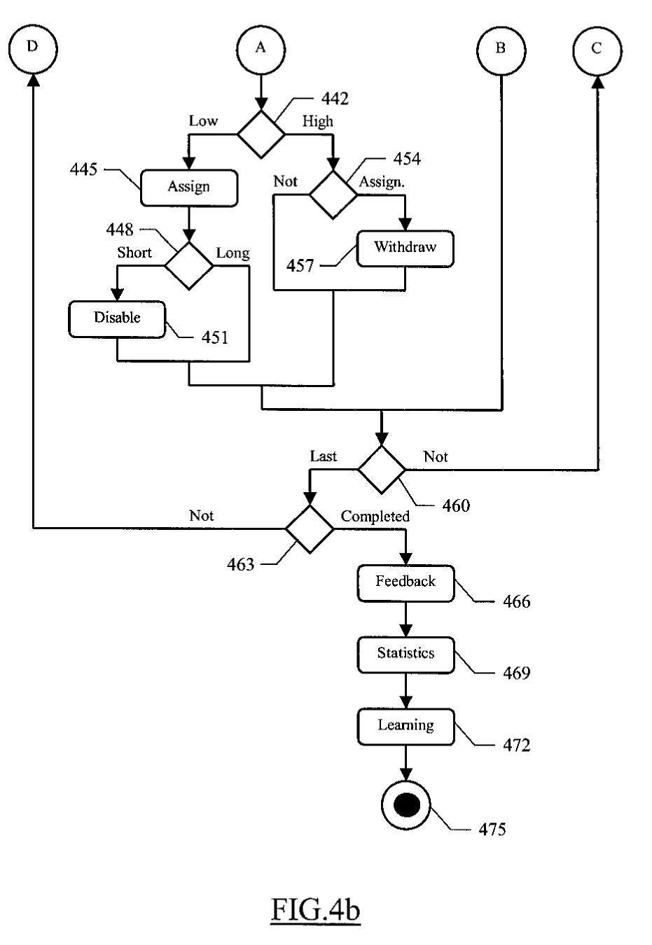

Considering now FIGS. 4a-4b, the logic flow of an exemplary process that can be implemented to schedule the execution of the jobs (monitoring the progress of the critical ones according to the above-described embodiment of the invention) is represented with a method 400.

The method 400 begins at the black start circle 403, and then passes to block 406 wherein a new plan for the next production period is created. Continuing to block 409, the handler starts the plan at the beginning of the production period. With reference now to block 412, the planner also adjusts the estimated total processor cycles of each planned critical job (extracted from the workload database), according to the corresponding adjustment factor that is provided by the classifier. The handler thus submits each job of the plan for execution as soon as possible at block 415.

The scheduler monitors the current progress of the running critical jobs periodically, as soon as a corresponding time-out expires at block 418. In response thereto, a loop is entered at block 421 wherein a next (running) critical job is processed (starting from the first one). For this purpose, a test is made at block 424 to determine whether the monitoring of the critical job was disabled (as described in the following). If not, the current processor cycles of the critical job are measured at block 427. Proceeding to block 430, the analyzer calculates the current progress of the critical job—dividing the current processor cycles by the (possibly adjusted) estimated total processor cycles. Likewise, the expected progress is calculated at block 433—dividing the elapsed time (from the actual start time of the critical job) by the allowable duration. Considering now block 436, the safety index of the critical job is calculated—dividing the current progress by the expected progress.

The flow of activity then branches at decision block 442. If the safety index is lower that the tolerance value (meaning that the critical job is late) the blocks 445-451 are executed, whereas if the safety index is equal to or higher than the same tolerance value (meaning that the critical job is on schedule) the blocks 454-457 are executed; in both cases, the process merges again at block 460.

Considering now block 445 (late critical job), the handler instructs the workload manager to assign additional resources to the critical job. A test is then made at block 448 to verify whether the time remaining to reach the required finish time of the critical job is lower than a predefined threshold (such as 10-20% of its estimated duration). In this case, the monitoring of the critical job is disabled at block 451, and the process descends into block 460; the same point is also reached from block 448 directly when the time remaining is more that the above-mentioned threshold. This additional feature prevents monitoring critical jobs uselessly. For example, this happens when the critical job was submitted very late (i.e., close to its required finish time or even later on); in this case, it is impossible to take back the critical job on schedule (so that it is not necessary to continue monitoring its progress, since the critical job will be always late).

With reference instead to block 454 (on-schedule critical job), a test is made to determine whether additional resources are assigned to the critical job (because it was late previously). If so, the same additional resources are withdrawn from the critical job at block 457, and the process descends into block 460; the same point is also reached from block 454 directly when no additional resources were assigned to the critical job.

In any case, a test is now made at block 460 to determine whether all the (running) critical jobs have been processed. If not, the flow of activity returns to block 421 to repeat the same operations for a next critical job. Conversely, the loop is exit descending into block 463. If the production period has not finished (and the plan has not been completed yet), the method goes back to block 418 to reiterate the same process. On the contrary, the feedback information (returned by the executor for each completed job) is saved into the workload database at block 466. Continuing to block 469, the estimator revises the statistics information relating to the completed jobs accordingly (updating their estimated duration and estimated total processor cycles). With reference now to block 472, the learner revises the decision trees of the completed jobs (according to their up-to-date statistics information). The method then ends at the concentric white/block stop circles 475.

Naturally, in order to satisfy local and specific requirements, a person skilled in the art may apply to the solution described above many modifications and alterations. Particularly, although the present invention has been described with a certain degree of particularity with reference to preferred embodiments) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, similar considerations apply if the system has a different architecture or includes equivalent units. Moreover, the scheduling server may have another structure or may include similar elements (such as cache memories temporarily storing the programs or parts thereof to reduce the accesses to the mass memory during execution). Moreover, the proposed solution lends itself to be implemented in a stand-alone computer, or more generally in a data processing system based on whatever code execution entity (such as a PDA, a mobile phone, and the like).

In any case, the invention has equal applicability to equivalent schedulers, which control the execution of streams of jobs, or more generally any other work units (such as interactive tasks); likewise, the plan may be created according to different rules. Moreover, nothing prevents the selection of the critical jobs with other criteria, or even the application of the proposed solution to all the jobs indiscriminately. Alternatively, it is possible to monitor the progress of the critical jobs with a different periodicity.

Any other value (or combination of values) may be used to indicate the lateness of each critical job (for example, based on the difference between the current progress and the expected progress); likewise, the critical job may be deemed late when an equivalent condition is satisfied (for example, based on a different tolerance value).

Similar considerations apply if the scheduler manages the assignment of the additional resources to the late critical jobs by means of any other component equivalent to the workload manager, or even directly by itself. The proposed solution is specifically designed for assisting the execution of the critical jobs automatically; however, nothing prevents using the same technique simply to warn an operator for the critical jobs that actually need assistance.

Alternatively, the additional resources may be assigned to the late critical jobs and/or withdrawn otherwise with equivalent algorithms (for example, with some sort of hysteresis).

Even though in the preceding description reference has been made to the processor cycles to measure the (current and expected) progress of the critical jobs, this is not to be interpreted in a limitative manner; for example, similar results may be achieved by measuring the number of I/O operations, the accesses to the hard-disks, or more generally the number of any other operations performed by the critical jobs.

Without departing from the principles of the invention, the estimated total processor cycles (or any equivalent metric) of each critical job may be predicted with different techniques—even statically (for example, according to the number of instructions of the critical job).

Similar considerations apply if the jobs are classified according to one or more alternative attributes (such as the 5 number of jobs concurrently executed on the system or a system load at its planned/actual time of execution); likewise, it is possible to model the jobs with other formalisms (for example, neural networks). In any case, the feature of adjusting the estimated total processor cycles of the critical jobs to be planned (according to their classes) is not strictly necessary and it may be omitted in some implementations of the invention.

In more sophisticated embodiments of the invention, it is also possible to model the expected progress of each critical job with different (non-linear) laws, reflecting the actual operation of the critical job more accurately.

Moreover, different conditions may be used to disable the monitoring of the critical jobs (for example, only when their actual start times follow the corresponding required finish times); however, nothing prevents monitoring the critical jobs in any case (such as for reporting purposes).

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (by using similar steps, removing some steps being not essential, or adding further optional steps—even in a different order). In any case, the program may take any form suitable to be used by or in connection with any data processing system, such as external or resident software, firmware, or microcode (either in object code or in source code). Moreover, it is possible to provide the program on any computer-usable medium; the medium can be any element suitable to contain, store, communicate, propagate, or transfer the program. For example, the medium may be of the electronic, magnetic, optical, electromagnetic, infrared, or semiconductor type; examples of such medium are fixed disks (where the program can be pre-loaded), removable disks, tapes, cards, wires, fibers, wireless connections, networks, broadcast waves, and the like.

In any case, the solution according to the present invention lends itself to be implemented with a hardware structure (for example, integrated in a chip of semiconductor material), or with a combination of software and hardware.

1. A method for scheduling execution of work units in a data processing system, the method including the steps of:
providing a plan of execution of the work units, the plan specifying a required finish time of at least one critical work unit,
submitting each work unit for execution at a corresponding start time,
monitoring a current progress of the execution of each critical work unit at a current time,
estimating an expected progress of the execution of each critical work unit at the current time, the expected progress being estimated according to a time elapsed from the start time to the current time with respect to an allowable duration from the start time to the finish time, and
determining an indication of lateness of each critical work unit according to a comparison between the current progress and the expected progress.

2. The method according to claim 1, wherein a set of execution resources of the system is assigned to each work unit being submitted for execution, the method further including the step of:
updating the resources assigned to each critical work unit according to the corresponding lateness.

3. The method according to claim 2, wherein the step of updating the resources assigned to each critical work unit includes:
assigning additional resources in response to the lateness reaching a predefined safety margin, and
withdrawing the additional resources otherwise.

4. The method according to claim 1, wherein the step of monitoring the current progress of the execution of each critical word unit includes:
measuring a current number of predetermined operations performed by the critical work unit at the current time, and
calculating the current progress according to the ratio between the current number and a total number of the operations to be performed by the critical work unit.

5. The method according to claim 4, further including the step of:
estimating the total number of the operations to be performed by each critical work unit according to a measured number of the operations being performed during a set of previous executions of the critical work unit.

6. The method according to claim 5, further including the step of:
adjusting the total number of the operations to be performed by each critical work unit according to the value of at least one attribute relating to the submission of the critical work unit for execution.

7. The method according to claim 1, wherein the step of estimating the expected progress of the execution of each critical work unit includes:
calculating the expected progress according to the ratio between the time elapsed and the available duration.

8. The method according to claim 1, further including the step of:
disabling the monitoring of each critical work unit in response to the difference between the required finish time and the current time being lower that a threshold value.

9. (canceled)

10. (canceled)

11. A scheduling system for scheduling execution of work units in a data processing system, the scheduling system including:
means for providing a plan of execution of the work units, the plan specifying a required finish time of at least one critical work unit,
means for submitting each work unit for execution at a corresponding start time,
means for monitoring a current progress of the execution of each critical work unit at a current time,
means for estimating an expected progress of the execution of each critical work unit at the current time, the expected progress being estimated according to a time elapsed from the start time to the current time with respect to an allowable duration from the start time to the finish time, and
means for determining an indication of lateness of each critical work unit according to a comparison between the current progress and the expected progress.

12. A computer program product in a computer-usable medium, the computer program when executed on a data processing system causing the system to perform a method for scheduling execution of work units in the system, wherein the method includes the steps of:
providing a plan of execution of the work units, the plan specifying a required finish time of at least one critical work unit,
submitting each work unit for execution at a corresponding start time,
monitoring a current progress of the execution of each critical work unit at a current time,
estimating an expected progress of the execution of each critical work unit at the current time, the expected progress being estimated according to a time elapsed from the start time to the current time with respect to an allowable duration from the start time to the finish time, and
determining an indication of lateness of each critical work unit according to a comparison between the current progress and the expected progress.
